(19) United States
(12) Patent Application Publication
(10) Pub. No.: US 2013/0283535 A1
(43) Pub. Date: Oct. 31, 2013

(54) Weight Distribution Device

(71) Applicant: Phillip West, Farmington, NM (US)

(72) Inventor: Phillip West, Farmington, NM (US)

(21) Appl. No.: 13/871,103

(22) Filed: Apr. 26, 2013

Related U.S. Application Data
(60) Provisional application No. 61/638,641, filed on Apr. 26, 2012.

(51) Int. Cl. B60N 2/44

(52) U.S. Cl. CPC B60N 2/44
USPC 5/653

(57) ABSTRACT

A weight distribution device for a seated person is disclosed. The weight distribution device comprises a seat cushion designed to elevate a user's buttocks and pelvic region significantly when the user is seated upon a vehicle seat. The weight distribution device distributes the weight of the seated person away from the user's ishial tuberosities by elevating the user's buttocks and pelvic region so that pressure on the user's ishial tuberosities is greatly reduced in relation to the rest of the user's anatomical structures in the buttocks and pelvic region.

### CROSS-REFERENCE

This application claims priority from Provisional Patent Application Ser. No. 61/638,641 filed Apr. 26, 2012.

### FIELD OF THE INVENTION

This invention pertains generally to a weight distribution device for a seated person, and more particularly to a seat cushion designed to elevate a user's buttocks and pelvic region thereby redistributing the weight of the seated person away from the user's ishial tuberosities by elevating the user's buttocks and pelvic region so that pressure on the user's ishial tuberosities is greatly reduced in relation to the rest of the user's buttocks and pelvic region.

### BACKGROUND

Many vehicle seat cushions can become uncomfortable, especially when driving or sitting in a vehicle for an extended period of time. The discomfort can lead to pain developing in the boney areas of a person's buttocks and pelvis. Over time, these boney portions of the pelvis may become irritated or inflamed, leading to chronic pain and conditions such as sciatica and bursitis that are aggravated every time he or she assumes a seated position. In the seated position, the body's weight is distributed to all parts of the buttocks. The ishial tuberosities are two bony protrusions located on either side of the buttocks that come in direct contact with a seat when someone sits down. However, because the ishial tuberosities protrude close to the surface, they bear the brunt of the weight. Furthermore, the ishial tuberosities are covered with a periosteum which is imbedded with nerve endings and attached to tendons. With prolonged pressure, the ishial tuberosities begin to suffer injury by becoming bruised or inflamed due to the pressure.

Consequently, there exists a need for a device to redistribute the weight of a seated person to reduce pressure on the ishial tuberosities. The present invention discloses a device that elevates the buttocks so that a seated body's weight is redistributed from front to back (pubis to coccyx) between the ishial tuberosities thereby reducing pressure over long periods of time while seated.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a weight distribution device for use on a seat configured to reduce pressure on a user's ishial tuberosities. The weight distribution device comprises a core element manufactured from a visco-elastic foam. The core element comprises an elongated triangular member with rounded edges. The elongated triangular member generally resembles three tubular lobes integrated into a single unit united along a central axis. The weight distribution device further comprises a cover for completely encapsulating the core element. The core element slides into the cover element and is secured with a zipper.

Furthermore, in a preferred embodiment, the core element is a single piece of visco-elastic or memory foam. The core element may be additionally encapsulated by a core element liner to reduce friction so that the cover element slides easily over the core element. To use the weight distribution device, a user places the weight distribution device on a vehicle seat so that a length of the weight distribution device is essentially perpendicular to a back of the vehicle seat. The user then sits down on the weight distribution device and weight is redistributed off of the user's ischial tuberosities and is redirected across the rest of the user's buttocks and pelvic region thereby increasing comfort.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of a weight distribution device in accordance with the disclosed architecture.

FIG. 2 illustrates a cross sectional view of the weight distribution device in accordance with the disclosed architecture.

FIG. 3 illustrates a perspective view of the weight distribution device in accordance with the disclosed architecture.

FIG. 4 illustrates a side view of the weight distribution device in use in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter. The invention relates generally to a device for redistributing the weight of a seated person so that there is less pressure exerted on the ishial tuberosities relative to the rest of a buttock.

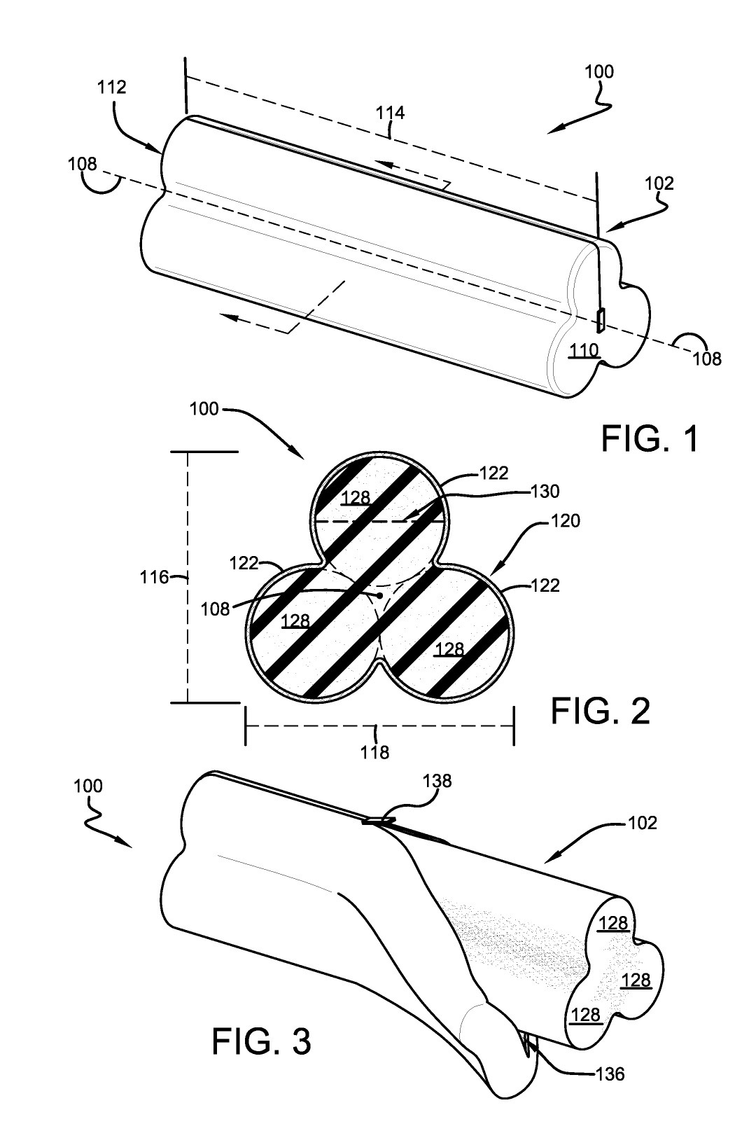

Referring initially to the drawings, FIGS. 1-4 illustrate a weight distribution device 100 for use with a seat, such as a vehicle seat. The weight distribution device 100 comprises a core element 102 and a cover element 134 for encapsulating the core element 102. The core element 102 comprises an elongated triangular member 104 and is configured to reduce pressure on a user's ishial tuberosities from the weight of a user while in a seated position. The weight of the user is essentially redistributed away from the ischial tuberosities which are the bony parts of the lower pelvis that protrude when the user sits down to the rest of the buttocks.

The ischial tuberosities, known as the “sitting bones,” are a pair of bony protuberances that extend posteriorly from the superior ramius of the ischium which is the lower portion of the pelvic bones. The ischial tuberosities essentially mark the lateral boundary of the pelvic outlet. When in a standing position, the gluteus maximus muscles protect the ischial tuberosities, but in a seated position, a significant portion of the weight is placed directly on the ischial tuberosities as they become exposed. Prolonged sitting may inflame the bursa or synovial sacs of the ischial tuberosities. Additionally, as the sciatic nerve runs adjacent, pressure on the nerve causing sciatic pain may result as well. The present invention redirects the pressure from the exposed bony projections to the muscle, soft tissue, and fatty regions of the buttocks.

Preferably, the weight distribution device 100 is a seat cushion for use on a vehicle seat during long trips; however, the weight distribution device 100 may also be used on any seating surface that the user may sit on for any extended period of time. The core element 102 comprises a resilient foam material. The resilient foam material is preferably visco-elastic foam or memory foam, but this is not meant as a limitation as any other material with similar properties as is known in the art may be used as well without affecting the overall scope of the invention, such as but not limited to polyurethane foam, low-resilience polyurethane foam, and the like. Visco-elastic foam is desirable because of the shape conforming and support characteristics of the material. Visco-elastic foam having a density of approximately between 4 and 5 lb/ft cubed has been found to provide adequate support for the buttocks while relieving pressure from the ischial tuberosities. Additionally, this material provides comfort to the user and quickly re-expands to its original shape when no longer in use.

The elongated triangular member 104 is configured with a cross-section 120 resembling an equilateral triangle with rounded corners 122. The elongated triangular member 104 has a diameter from a center axis 108 of approximately between six and nine inches to accommodate users of different sizes and weights. The elongated triangular member 104 further comprises a first end 110 and a second end 112 to define a length 114. Either the first end 110 or the second end 112 is placed on the seat substantially perpendicular to a back of the vehicle seat. The length 114 is between approximately 12 and 20 inches and is long enough that, when placed upon a seat in the manner described, extends beyond the front to back dimensions of a user's central bottom anatomy. The elongated triangular member 104 is further defined with a height 116 and a base 118. The base 118 is a length of any of the three sides of the elongated triangular member 104 and allows the weight distribution device 100 to rest essentially flat on the seat.

Although the elongated triangular member 104 is conformed into a single unit of material, the elongated triangular member 104 further comprises three tubular lobes 128. The three tubular lobes 118 essentially resemble round cylinders running the length 114 of the elongated triangular member 104. Each of the three tubular lobes 118 has a diameter 130 of approximately between 2½ and 4¼ inches. Additionally, the three tubular lobes 118 are integrated into the single unit of material along the center axis 108. The three tubular lobes 118 further define the cross-section 120 with concave sections 124 and convex sections 126. Therefore, each base 118 or side is slightly concave, and the convex sections 126 are created by the rounded corners 122 creating an essentially three leaf clover cross sectional shape. This is desirable, as a top pointed corner of a traditional triangular cushion tends to fold over upon itself unpredictably resulting in a lump along one side. The convex shape solves this problem by compressing an apex of the elongated triangular member 104 downward upon itself instead of off to one side.

The weight distribution device 100 may further comprise a core element liner (not shown). As visco-elastic foam is slightly tacky, the core element liner essentially encapsulates the core element 102 like a skin. This decreases friction between the core element 102 and the cover element 134 allowing the cover element 134 to easily slide over the core element 102. The core element liner is typically a thin piece of polyester material completely surrounding the core element 102 and is sewn in place.

As illustrated in FIG. 3, the cover element 134 comprises a washable breathable fabric such as but not limited to denim or polyester fabric, although any similar material may be used without affecting the overall scope of the invention. The cover element 134 is dimensioned to fit snugly over the core liner element. The cover element 134 comprises a closeable opening 136 running approximately the length 114 of the elongated triangular member 104. This allows the user to simply slide the elongated triangular member 104 into the cover element 134. The closeable element 136 is openable and closeable with a zipper 138, however, it may also comprise hook and loop fasteners, mechanical fasteners, and the like. Preferably, the zipper 138 is a low profile zipper for increased comfort of the user.

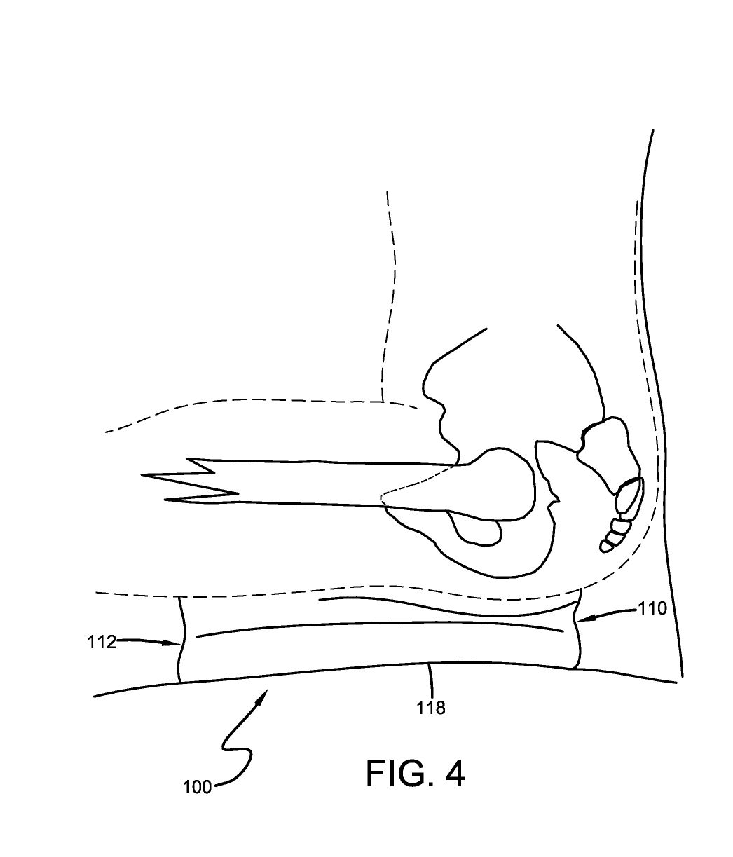

As illustrated in FIG. 4, to use the weight distribution device 100, the user simply places it on the vehicle seat with the length 114 perpendicular to the back of the seat. The user sits down on the weight distribution device 100 so that the length 114 is centrally positioned and runs between a user's buttocks. The height 116 extends upward along a center line between the user's buttocks elevating the buttocks off of the seat sufficiently to an extent that it results in a redistribution of the pressure throughout the area, and a resulting reduction of the pressure upon the ischial tuberosities is achieved.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A weight distribution device for use with a seat comprising:
a core element configured to reduce pressure on a user's ischial tuberosities while in a sitting position, the core element further comprising:
an elongated triangular member comprising three tubular lobes integrated along a center axis; and
a cover element for encapsulating the core element.

2. The weight distribution device of claim 1, wherein the core element comprises a material for reducing pressure upon the ischial tuberosities while supporting a user's buttocks and a pelvic region.

3. The weight distribution device of claim 3, wherein the material is visco-elastic foam.

4. The weight distribution device of claim 1, wherein the core element is a single piece of visco-elastic foam.

5. The weight distribution device of claim 1, wherein a diameter of the core element is approximately between 6 and 9 inches.

6. The weight distribution device of claim 1, wherein a diameter of each of the three tubular lobes is approximately between 2½ and 4½ inches

7. The weight distribution device of claim 1, wherein the core element further comprises a substantially equilateral triangular component with rounded corners.

8. A weight distribution device for use with a seat comprising:
a core element configured to reduce pressure on a user's ischial tuberosities while in a sitting position, the core element further comprising:
an elongated triangular visco-elastic foam member comprising three tubular lobes integrated along a center axis; and
a cover element for encapsulating the core element.

9. The weight distribution device of claim 8, wherein the core element is approximately between 12 and 16 inches in length.

10. The weight distribution device of claim 9, further comprising a core element liner encapsulating the core element for reducing friction between the core element and the cover element.

11. The weight distribution device of claim 8, wherein the elongated triangular visco-elastic foam member comprises a base and a height, and wherein the base rests substantially flat on the seat and the height extends upward towards a user in a seated position.

12. The weight distribution device of claim 8, wherein the elongated visco-elastic foam member has a density of approximately between 4 and 5 lb/ft cubed.

13. The weight distribution device of claim 8, wherein the cover element comprises a closeable opening extending approximately a length of the core element.

14. The weight distribution device of claim 13, wherein the closeable opening comprises a low profile zipper.

15. A weight distribution seat cushion device for use with a vehicle seat comprising:
a core element configured to reduce pressure upon a user's ischial tuberosities while redistributing pressure to a user's buttocks and pelvic region while in a sitting position, the core element further comprising:
an elongated triangular member comprising three tubular lobes integrated along a center axis, wherein the elongated triangular member is positioned on the vehicle seat substantially perpendicular to a back of the vehicle seat; and
a cover element for encapsulating the core element.

16. The seat cushion of claim 15, wherein the three tubular lobes are integrated into a single unit of visco-elastic foam.

17. The seat cushion of claim 15, wherein the cover element comprises a zippered closeable opening extending approximately a length of the core element.

18. The seat cushion of claim 15, further comprising a core element liner encapsulating the core element for reducing friction between the core element and the cover element.

19. The seat cushion of claim 15, wherein the core element is approximately between 14 and 20 inches in length and is approximately between 6 and 9 inches in diameter.

20. The seat cushion of claim 15, wherein the cover element comprises a breathable fabric.
